(19) United States
(12) Patent Application Publication
(10) Pub. No.: US 2003/0036380 A1
(43) Pub. Date: Feb. 20, 2003

(54) Method of data transfer

(76) Inventor: Adrian Gary Skidmore, Ludgersgall (GB)

Correspondence Address: CROWELL & MORING LLP, INTELLECTUAL PROPERTY GROUP, P.O. BOX 14300, WASHINGTON, DC, 20044-4300, US

(21) Appl. No.: 10/208,015

(22) Filed: Jul. 31, 2002

(30) Foreign Application Priority Data
Aug. 22, 2001 (GB) 0120380.1
Aug. 1, 2001 (GB) 0118709.5

(51) Int. Cl. H04Q 7/00

(52) U.S. Cl. 455/414; 455/466

(57) ABSTRACT

A method of controlling data transfer to a remote user comprises defining a set of user preferences, scanning a data source for data satisfying the defined user preferences and setting a trigger comprising a specified change in data matching a pre-defined query. The method monitors for occurrence of the trigger and sends a message to a mailbox of the user, automatically transferring data from the data source to the remote user, only if the trigger is satisfied. The method is particularly applicable for mobile phone users wishing to obtain data from the internet via a local PC.

This invention relates to a method of data transfer, in particular for controlling data transfer between a mobile phone and the internet.

Wireless applications protocol (WAP) allows mobile phone users to access internet-like services, however this does not give the user a great deal of control over what they receive, the user is generally charged while online and it is in a format which is unfamiliar to users of the conventional internet. Some services are provided by mobile phone operators which push certain data to users from a list of pre-defined topics such as sport, weather or stock market news, but these are very general and restricted.

In accordance with a first aspect of the present invention, a method of controlling data transfer to a remote user, comprises defining a set of user preferences; scanning a data source for a trigger related to the defined user preferences; when a trigger occurs, sending a message to a mailbox of the user; and transmitting data extracted from the data source to the remote user.

The present invention allows a remote user to define a set of criteria which must be satisfied before any data is sent to the user. Used with a mobile phone, this has the advantage that the user can surf the internet for data of interest, but this is filtered in the server and only essential relevant data is downloaded on the user's phone. Preferably, the remote user is a mobile phone user.

Preferably, the message is a short message service (SMS) text message.

Preferably, the data source is a predetermined set of web pages.

Various triggers may be used, but preferably the trigger is one of a change in data on a web page matching a pre-defined query stored in a local query database; a specified change in a specified data value on a predetermined web page; and an email sent by the remote user requesting content from a web page.

An example of a method of controlling data transfer to a remote user according to the present invention will now be described with reference to the accompanying drawings in which:-

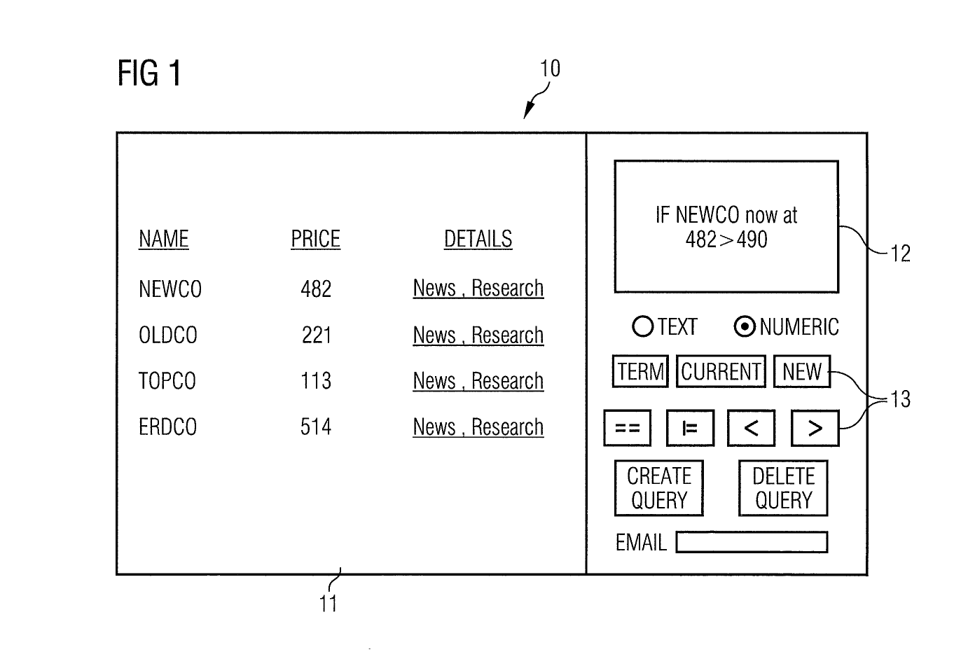

FIG. 1 illustrates a query builder for use with the method of the present invention; and

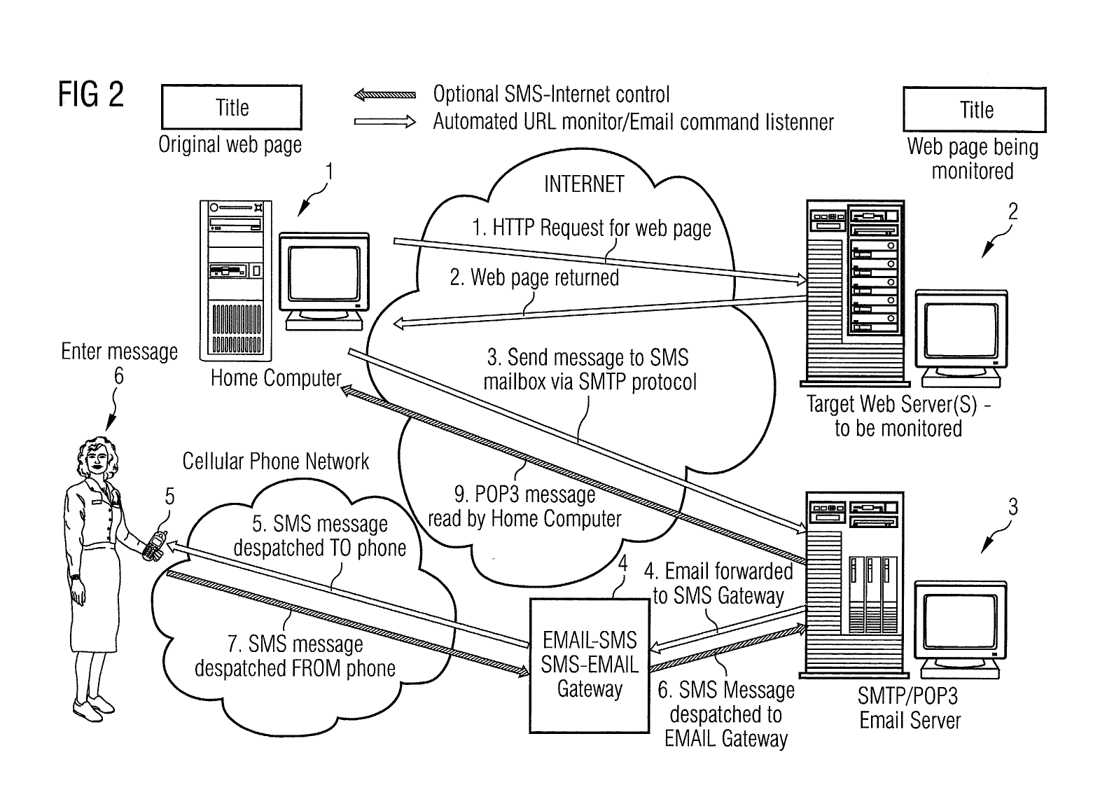

FIG. 2 is a simplified block diagram of an internet tracker/SMS/internet controller for operating the method of the present invention.

Prior art systems tend to push particular data, but do not give the user flexibility. For example, in banking systems, statements can be sent to the user's phone in response to a transaction occurring on the account, but the user cannot choose the conditions under which this happens. The present invention allows the user to choose to receive the statement only if it contains specific data, such as a particular cheque being cashed or an expenses claim paid in, and to control those conditions via his phone, rather than having to set up changes via his home PC. The method of the present invention makes use of the flexibility of a mobile phone in combination with a fixed internet connection. The user is able to use a web browser-like application on a PC to select any familiar web page, navigate the page as normal and compose specific queries based on the content, specifying a URL, text term, instance of that term (automatically calculated) from the page and trigger condition, for monitoring. This is illustrated in FIG. 1 which shows a screen 10 displaying a web page 11 providing for example share price information on the left hand side of the screen and provided with a query builder 12 on the right hand side of the screen. The user can drag a company name on the screen onto the query builder, add some text information, choose various operators 13 and provide an email address to which the data will be sent when the trigger occurs. In the example, Newco has a current share price of 482 and the query has been set up to send a message when the current share price is greater than 490.

Information can also be requested from any internet web page in real time, via SMS. A user can set up on his home PC, a series of web pages and parameters of interest on those pages which act as triggers, or he can set up and change those parameters via his mobile phone. The parameters of interest may include, for example, a change in a specific share price or the addition of any new data on a chosen page, or receipt of an incoming email. When a trigger occurs, the home PC sends an SMS message to the mobile via an email server, with the data of interest. If the trigger is an incoming email, the email may be a new request to search for particular data and so, has the effect of prompting a web page to be searched in real-time, a web page is then accessed and if a match is made, text is returned to the user via SMS, up to 160 characters. An example of the method is described in more detail with reference to FIG. 2.

A PC 1 is set up with the user's preferences and sends an http request to a target Web server 2. The desired Web page is returned to the PC. If any trigger occurs, e.g. a change in a predefined share price, the PC sends a message to the mobile user's SMS mailbox via SMTP protocol. This mailbox is generally held on a dedicated server 3 run by a service provider. The mailbox server forwards the email to an SMS gateway 4 which dispatches the message to the user's mobile phone 5.

The user can set a limit on the number of SMS messages which are sent out in response to a trigger over a predefined period, or chose to lock-out further triggers, to prevent multiple SMS messages when a trigger condition is met and changes too frequently.

Multiple conditions can be entered in the query, such as a requirement that if a particular flight no. is delayed by more than 1 hour, the user will be notified. If a delay is marked up, but only for 30 minutes, then no data is transferred to the user.

The system can work with a single home PC as the server linked to the internet via a broadband link, or it can be configured as a subscription based service provided from a commercial server, for multiple users. In this case the PC of the example of FIG. 1 might be combined with the email server, if the same service provider was used. The home PC user can take advantage of fixed price “always-on” internet services, so that call charges are not significant. The other parts of the infrastructure required for using this method already exist. An SMTP and POP3 email server is provided by the user's internet service provider and email-SMS gateways are provided by major telephone service providers.

The home PC configuration file contains URLs of web pages to monitor; any fields or values to be checked and triggers; command look-up table instructions to perform on receiving commands; SMS message limit; delay period; and confirm command. When the user receives notification of a trigger (stage 6 of FIG. 1), the user can enter a message in the following form:

Subject=SMSWEB

Message content=command required

Press SEND to phone company email gateway.

To improve security of the system, a simple password could be required as a prefix to commands sent via SMS by the remote user from the user's mobile phone. The password is verified before executing the command given. The user may also pre-set a time frame for response and a requirement that commands are only executed in response to an outgoing message from the home PC. Similarly, that outgoing message may be constrained to being one generated in response to a trigger.

The present invention allows automatic SMS notification of textual user defined web (html) content for any conventional web page that the user chooses. The application reformats the items of interest which are being monitored or requested via SMS to text and returns the content via SMS. Applications include share price triggers, which cause shares to be bought or sold at a particular price, racing results or financial transaction checking for personal bank accounts. The arrival of a new email via SMS can be notified to the user, including redirecting the subject line and the first few lines of the message. The system can also be used to track status of online auctions, when bids change. By providing the facility for the remote user to send a command from a mobile phone which is actioned from the home computer, the user can update a current bid simply by sending a number which will be treated in a predetermined way, e.g. as an increase to the existing bid.

An example of possible application code is set out below.

REPEAT UNTIL SMS_message_count > SMS_message_limit

Check current web page for information of interest

IF information of interest causes a trigger

THEN

Package SMS message and send to SMTP email server
Increment SMS_message_count

ENDIF
Check POP3 email server for incoming messages
IF message subject = SMSWEB
THEN

Look-up command and decode message
Access the internet and perform command
IF confirm_command = TRUE

Package SMSCONFIRM message and send to STMP email server
Increment SMS_message_count

ENDIF

ENDIF

WAIT Delay_Period

END REPEAT

1. A method of controlling data transfer to a remote user, the method comprising defining a set of user preferences; scanning a data source for data satisfying the defined user preferences; setting a trigger comprising a specified change in data matching a pre-defined query; monitoring for occurrence of the trigger, sending a message to a mailbox of the user; and automatically transferring data from the data source to the remote user, only if the trigger is satisfied.

2. A method according to claim 1, wherein the remote user comprises a mobile phone user.

3. A method according to claim 1, wherein the message is a short message service (SMS) text message.

4. A method according to claim 1, wherein the data source comprises a predetermined set of web pages on a web server.

5. A method according to claim 1, wherein the pre-defined query is created by the user in graphical format.

6. A method according to claim 1, wherein creation of the predefined query comprises a series of interactions between the user and the web server, at the end of which a query is created which is fixed by the user.

7. A method according to claim 1, wherein the pre-defined query includes at least two variables.
